(19) United States
(12) Patent Application Publication
(10) Pub. No.: US 2019/0178665 A1
(43) Pub. Date: Jun. 13, 2019

(54) DESTINATION ESTIMATION APPARATUS, DESTINATION ESTIMATION SYSTEM, AND DESTINATION ESTIMATION METHOD

(71) Applicants: DENSO TEN Limited, Kobe-shi (JP); TOYOTA JIDOSHA KABUSHIKI KAISHA, Toyota-shi (JP)

(72) Inventors: Yusuke SAKAIDA, Kobe-shi (JP); Taisuke TONE, Toyota-shi (JP); Xin JIN, Nagoya-shi (JP); Atsushi KUBO, Toyota-shi (JP); Miharu HANAI, Obu-shi (JP); Youichi SUZUKI, Toyota-shi (JP)

(73) Assignees: DENSO TEN Limited, Kobe-shi (JP); TOYOTA JIDOSHA KABUSHIKI KAISHA, Toyota-shi, Aichi-ken (JP)

(21) Appl. No.: 16/198,990

(22) Filed: Nov. 23, 2018

(30) Foreign Application Priority Data
Dec. 12, 2017 (JP) 2017-237850

(51) Int. Cl. G01C 21/34; G01C 21/20

(52) U.S. Cl. CPC G01C 21/3484; G01C 21/367; G01C 21/20

(57) ABSTRACT

A destination estimation apparatus according to the present invention includes: a storage unit that stores information about at least one stop location of a vehicle used by a user and information about at least one past plan of the user in association with each other; and a destination estimation unit that estimates a destination with respect to information about a future plan of the user, based on the information about one of the at least one stop location that is associated with the information about one of the at least one past plan stored in the storage unit that corresponds to the information about the future plan.

### CROSS-REFERENCE TO RELATED APPLICATIONS

This application is based upon and claims the benefit of prior Japanese Patent Application No. 2017-237850 filed on Dec. 12, 2017, the entire contents of which are incorporated herein by reference.

### FIELD

The present invention relates to a destination estimation apparatus, a destination estimation system, and a destination estimation method.

### BACKGROUND

Conventionally, an apparatus including a schedule information acquisition unit that acquires schedule information of a user and an estimation unit that estimates a destination based on the acquired schedule information has been proposed (for example, Japanese Patent Laid-Open No. 2016-61578). In this technology, a key word (a place, a detail, or the like) is extracted from the schedule information of the user by using a known character string analysis technique and, when the key word includes a character string indicating a place, it is estimated that the place is a destination. When the key word does not include a character string indicating a place, the key word is regarded as a destination.

[Patent document 1] Japanese Patent Laid-Open No. 2016-61578

[Patent document 2] Japanese Patent Laid-Open No. 2012-145432

### SUMMARY

### Technical Problem

Techniques for estimating a destination based on a key word input in a schedule by a user have been proposed conventionally. However, a destination cannot be estimated, for example, when a general name is input for a destination or a detail in a schedule, or when a personal name, a store name, or the like that cannot uniquely identify a place is input in a schedule.

Accordingly, an object of the present invention is to enhance accuracy of estimation of a destination when a user does not input information that can identify the destination in a plan of the user.

### Solution to Problem

A destination estimation apparatus according to the present invention includes: a storage unit that stores information about at least one stop location of a vehicle used by a user and information about at least one past plan of the user in association with each other; and a destination estimation unit that estimates a destination with respect to information about a future plan of the user, based on the information about one of the at least one stop location that is associated with the information about one of the at least one past plan stored in the storage unit that corresponds to the information about the future plan.

With this configuration, a destination of a future plan of the user can be estimated based on a combination of a past plan and a stop location of the vehicle. That is, accuracy of estimation of a destination is enhanced even if the user does not input any information that can identify the destination in a plan of the user. Note that the estimated destination may be added to the information about the plan of the user.

The destination estimation apparatus may further include: a plan acquisition unit that acquires from another apparatus the information about the at least one past plan and the information about the future plan, which are input by the user into the other apparatus, and stores the acquired information in the storage unit; and a stop location acquisition unit that acquires information indicating a date and a time when and a location where the vehicle is stopped from a vehicle-mounted apparatus mounded on the vehicle, and stores the acquired information in the storage unit as the information about the at least one stop location of the vehicle. By having acquired information about a past plan and information indicating a date and a time when and a location where the vehicle was stopped, the destination estimation apparatus can perform the above-described estimation processing.

The information about the at least one past plan of the user includes information indicating a starting date and time of the at least one past plan, and the destination estimation apparatus may further include an association control unit that reads from the storage unit information indicating a location where the vehicle was stopped within a predetermined time range by using the starting date and time of the at least one past plan as a reference, and stores the read information indicating the location of the vehicle and the information about the at least one past plan in association with each other. With a simple database formed by associating information about a past plan and information indicating a location where the vehicle is stopped in this manner, the above-described estimation processing can be performed.

The information about the future plan and the information about the at least one past plan further include information indicating details of the respective plans, and with respect to the information about the future plan of the user, the destination estimation unit may extract the information about one of the at least one past plan that includes the same information indicating the detail of the plan as that of the information about the future plan, and estimate that a stop location indicated by the information about one of the at least one stop location that is associated in the storage unit with the extracted information about the one of the at least one past plan is a destination. With this configuration, a destination of a plan can be estimated based on a trend of information registered by the user regarding the plan, and accuracy of the estimation can be enhanced.

A destination estimation system according to another aspect of the present invention includes: any one of the above-described destination estimation apparatuses; and an apparatus that is connected to the destination estimation apparatus via a network and that provides route guidance toward a destination estimated by the destination estimation unit. The apparatus that provides route guidance may be a vehicle-mounted apparatus, or may be a communication terminal owned by the user. With this configuration, it is possible to save the user time and trouble to register a destination in a so-called car navigation system or a navigation app, and consequently usability is enhanced.

Note that the contents described in SUMMARY OF THE INVENTION can be combined to the extent possible without departing from the scope of the problems to be solved by the present invention and the technical idea of the present invention. Moreover, the contents of SUMMARY OF THE INVENTION can also be implemented as methods to be performed by a computer or as programs to be executed by a computer. Recording media storing such programs may also be provided.

### Advantageous Effect of Invention

It is possible to enhance accuracy of estimation of a destination when a user does not input information that can identify the destination in a plan of the user.

### BRIEF DESCRIPTION OF THE DRAWINGS

FIG. 1 is a schematic diagram depicting an example of a destination estimation system;

FIG. 2 is a functional block diagram depicting an example of a communication terminal;

FIG. 3 depicts an example of a plurality of pieces of plan information stored in a plan storage unit;

FIG. 4 is a functional block diagram depicting an example of a vehicle-mounted apparatus;

FIG. 5 depicts an example of stop location information stored in a stop location storage unit;

FIG. 6 is a functional block diagram depicting an example of a server;

FIG. 7 depicts an example of associated information, which is formed by associating stop information with a title of a plan;

FIG. 8 depicts an example of first association processing;

FIG. 9 depicts an example of second association processing;

FIG. 10 depicts an example of first destination estimation processing;

FIG. 11 depicts an example of an output for inquiring whether or not an estimated destination can be added to plan information;

FIG. 12 depicts an example of updated plan information;

FIG. 13 depicts an example of second destination estimation processing; and

FIG. 14 depicts an example of an output for inquiring whether or not a candidate for destination can be set as a destination on a navigation system.

### DESCRIPTION OF EMBODIMENT

Hereinafter, an embodiment of the present invention will be illustrated with reference to the accompanying drawings. However, the present invention is not limited to the configuration of the embodiment.

<System Configuration>

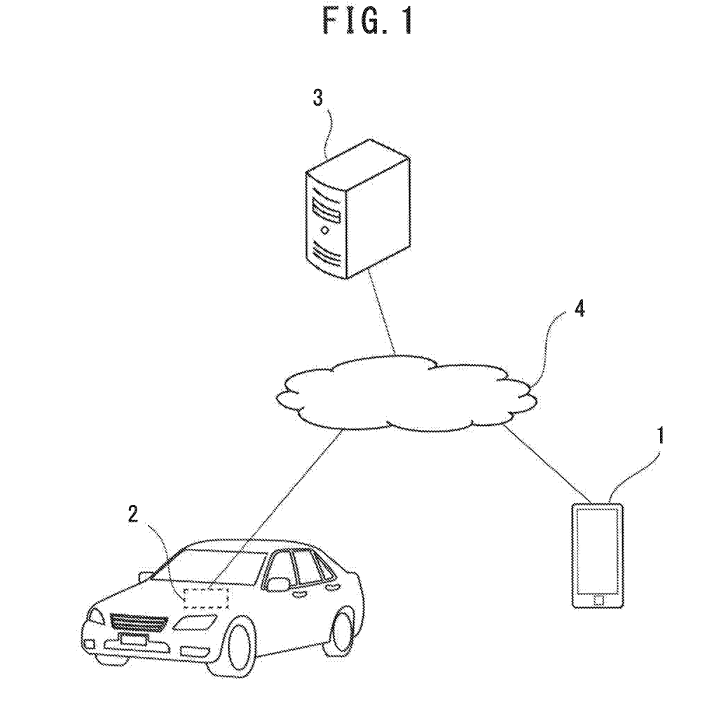

FIG. 1 is a schematic diagram depicting an example of a destination estimation system according to the present embodiment. The destination estimation system includes a communication terminal 1 owned by a user of the system, a vehicle-mounted apparatus 2 mounted on a vehicle, and a server 3 that performs destination estimation processing, and these components are communicably connected to each other via a network 4 such as the Internet.

The communication terminal 1 is a computer having a communication function, such as a mobile telephone, a smartphone, a PC (Personal Computer), or a tablet. It is assumed that the communication terminal 1 includes a schedule management function capable of registering a plan of the user, for example, on a calendar, or can use a service (not shown) for providing a schedule management function on so-called cloud computing. In the present embodiment, information about each individual plan registered in the schedule management function will be referred to as “plan information”.

The vehicle-mounted apparatus 2 is an apparatus, such as a navigation system, mounted on the vehicle, and is assumed to be capable of finding a location of the vehicle by using a GPS (Global Positioning System) unit. Moreover, it is assumed that the vehicle-mounted apparatus 2 has a communication function. The vehicle-mounted apparatus 2 is connected to, for example, an ECU (Electronic Control Unit) of the vehicle and detects that an accessory (ACC) power supply is turned off (also referred to as “ACC-OFF”). Based on the detection of ACC-OFF, the vehicle-mounted apparatus 2 stores information including a place where and a date and a time when the vehicle was stopped. In the present embodiment, information about a stop of the vehicle including a place and a date and a time will be referred to as “stop information”.

The server 3 has a communication function and is a computer that provides its own functions to another apparatus connected to the server 3 via the network 4. Moreover, the server 3 associates past plan information registered by the user in the communication terminal 1 or in a schedule management program on the cloud computing, with a place where the vehicle was stopped on or around a starting time registered in the past plan information, thereby accumulating data on destinations corresponding to plan information. The server 3 estimates a destination for plan information newly input by the user, based on the accumulated data indicating combinations of plan information and a destination. The server 3 corresponds to a “destination estimation apparatus” according to the present invention.

Note that it is assumed that a schedule of the user who uses the system and the vehicle-mounted apparatus 2 mounted on the vehicle used by the user are configured in advance to correspond with each other. Moreover, it is assumed that a “stop” in the present embodiment simply refers to stopping the vehicle. That is, it is assumed that an object of stopping the vehicle is ignored, and that a “stop” is not limited to a temporary stop but includes parking, which means continually stopping the vehicle.

<Communication Terminal>

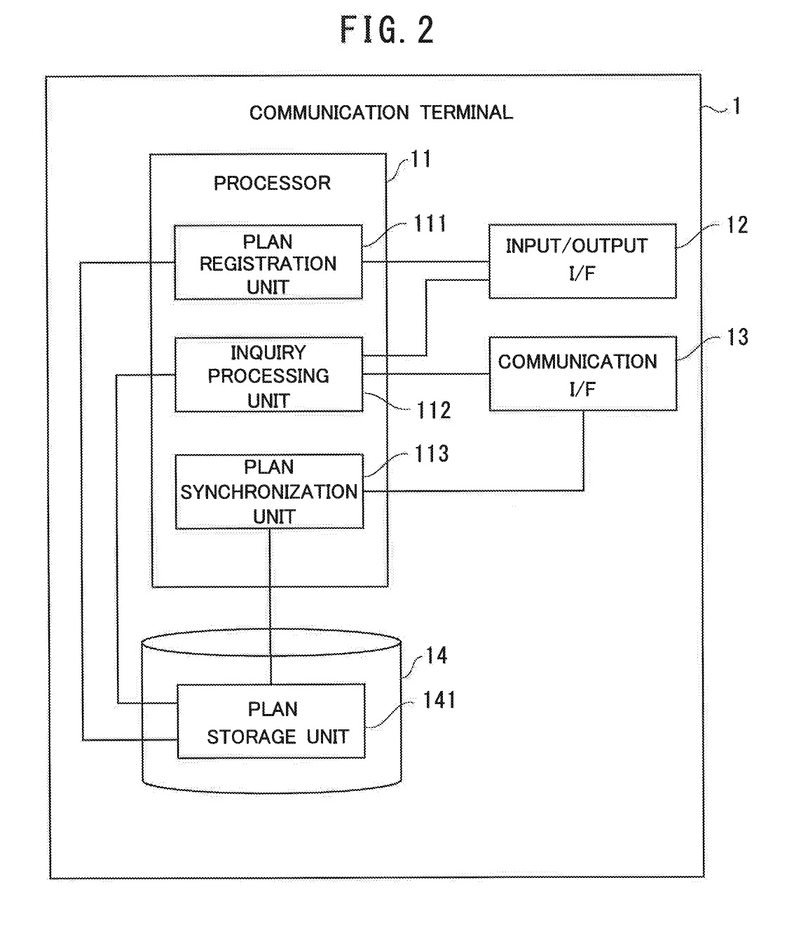

FIG. 2 is a functional block diagram depicting an example of the communication terminal. The communication terminal 1 is a so-called computer and includes a processor 11, an input/output interface (I/F) 12, a communication interface (I/F) 13, and a main memory 14. The processor 11 is a processing device such as a CPU (Central Processing Unit). The input/output I/F 12 is, for example, a touch panel and includes an input unit that accepts an operation of the user, such as a touch pad, and an output unit that outputs information to the user, such as a display device. The communication terminal 1 accepts an operation of the user and outputs information to the user via the input/output I/F 12. Note that the input/output I/F may be configured with the input unit and the output unit that are separated, such as a keyboard and a monitor. The communication I/F 13 is, for example, a wireless communication module that performs communication based on a predetermined standard. The communication terminal 1 can communicate via the communication I/F 13 with another computer connected to the network 4. The main memory 14 includes main memories such as a RAM (Random Access Memory) and a ROM (Read Only Memory), and one or more secondary storage such as an HDD (Hard-disk Drive), an SSD (Solid State Drive), an eMMC (embedded Multi-Media Card), and a flash memory. The main memory 14 stores a program to be executed by the processor 11 and plan information input by the user.

Moreover, the processor 11 executes a predetermined program, thereby serving as a function unit for each of a plan registration unit 111, an inquiry processing unit 112, and a plan synchronization unit 113. At least a partial area of the main memory 14 serves as a plan storage unit 141 in which the plan information input by the user is stored.

The plan registration unit 111 accepts an operation of the user via the input/output I/F 12 and puts plan information of the user in the plan storage unit 141. It is assumed that predetermined input items are configured in the plan information so that, for example, a title of a plan and a starting time thereof are registered in the plan information. Note that a finishing time of the plan, a place thereof, alarm setting, and any other item may further be registered in the plan information.

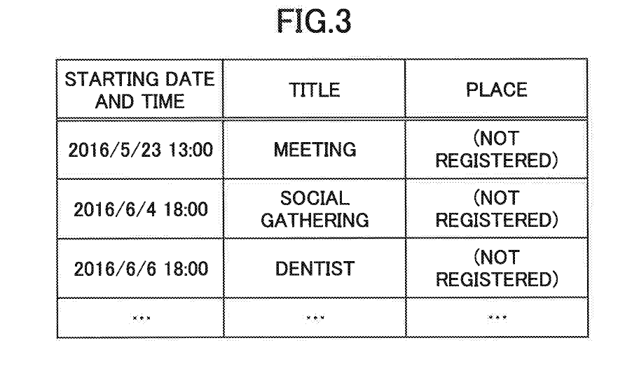

FIG. 3 depicts an example of a plurality of pieces of plan information stored in the plan storage unit. The plan information can be stored in a table of a so-called database (DB). The table of FIG. 3 includes attributes of “starting date and time”, “title”, and “place”. In a field of “starting date and time”, information indicating a date and a time when a plan is started is registered. In a field of “title”, information indicating a detail of the plan is registered. In a field of “place”, information indicating a place where the plan is conducted is registered. However, information is not necessarily registered in a field of “place”.

The inquiry processing unit 112 receives, via the communication I/F 13, a destination estimated by the server 3 for plan information with a field of “place” in which no information is registered. The inquiry processing unit 112 proposes the destination estimated by the server 3 to the user via the input/output I/F 12 and, when the user makes an operation for acknowledging the proposal, updates the plan information in the plan storage unit 141.

The plan synchronization unit 113 sends plan information newly registered by the plan registration unit 111 or plan information updated by the inquiry processing unit 112 to the server 3 via the communication I/F 13, to have the plan information synchronize with plan information managed by the server 3.

<Vehicle-Mounted Apparatus>

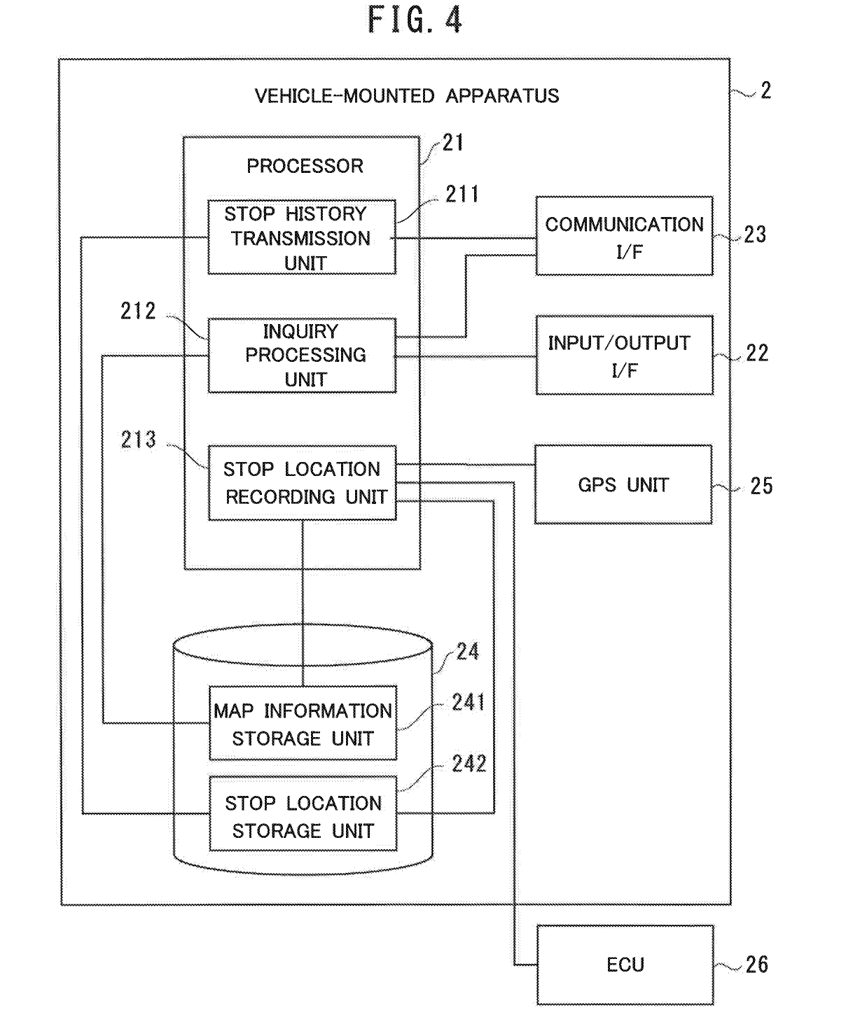

FIG. 4 is a functional block diagram depicting an example of the vehicle-mounted apparatus. The vehicle-mounted apparatus 2 is a computer such as a navigation system. The vehicle-mounted apparatus 2 includes a processor 21, an input/output interface (I/F) 22, a communication interface (I/F) 23, a main memory 24, and a GPS unit 25. The vehicle-mounted apparatus 2 is connected to an ECU 26 mounted on the vehicle. The ECU 26 is an electronic control unit that controls an engine, an air conditioner, and the like. In the present embodiment, it is assumed that the ECU 26 activates the vehicle-mounted apparatus 2 when an accessory power supply is turned on, and terminates operation of the vehicle-mounted apparatus 2 when the accessory power supply is turned off, based on a state of an ignition switch of the vehicle. The processor 21 is a processing device such as a CPU. The input/output I/F 22 is, for example, a touch panel and includes an input unit that accepts an operation of the user, such as a touch pad, and an output unit that outputs information to the user, such as a display device. The vehicle-mounted apparatus 2 also accepts an operation of the user and outputs information to the user via the input/output I/F 22. Note that the input/output I/F 22 may be configured with the input unit and the output unit that are separated, such as a keyboard and a monitor. The communication I/F 23 is, for example, a wireless communication module that performs communication based on a predetermined standard. The vehicle-mounted apparatus 2 can communicate via the communication I/F 23 with another computer connected to the network 4. The main memory 24 includes main memories such as a RAM and a ROM, and one or more secondary storage such as an HDD, an SSD, an eMMC, and a flash memory. The main memory 24 stores a program to be executed by the processor 21 and information indicating a location where the vehicle is stopped. The information indicating a location where the vehicle is stopped includes a date and a time when the accessory (ACC) power supply is turned off (also referred to as “ACC-OFF”) and a then stop location.

Moreover, the processor 21 executes a predetermined program, thereby serving as a function unit for each of a stop history transmission unit 211, an inquiry processing unit 212, and a stop location recording unit 213. At least a partial area of the main memory 24 serves as a map information storage unit 241 in which information indicating a map is stored, and as a stop location storage unit 242 in which a history of locations where the vehicle is stopped is stored.

The stop history transmission unit 211 sends stop location information including a date and a time when and a location where the vehicle was stopped to the server 3 via the communication I/F 23 at a predetermined timing.

The inquiry processing unit 212 proposes a destination estimated by the server 3 to the user via the input/output I/F 22 and, when the user makes an operation for acknowledging the proposal, sets the destination on a navigation function (not shown) included in the vehicle-mounted apparatus 2.

The stop location recording unit 213 receives information indicating ACC-OFF from the ECU 26. The stop location recording unit 213 acquires information indicating a date and a time from a built-in clock (not shown) such as a real-time clock (calendar clock) included in the vehicle-mounted apparatus 2. Moreover, the stop location recording unit 213 acquires information indicating a location of the vehicle including a latitude and a longitude at the time of ACC-OFF from the GPS unit 25. In this event, the stop location recording unit 213 may convert the latitude and longitude into an address by referring to the information stored in the map information storage unit 241 of the main memory 24. The stop location recording unit 213 then puts stop location information including the date and time when and the location where the vehicle is stopped, in the stop location storage unit 242 of the main memory 24.

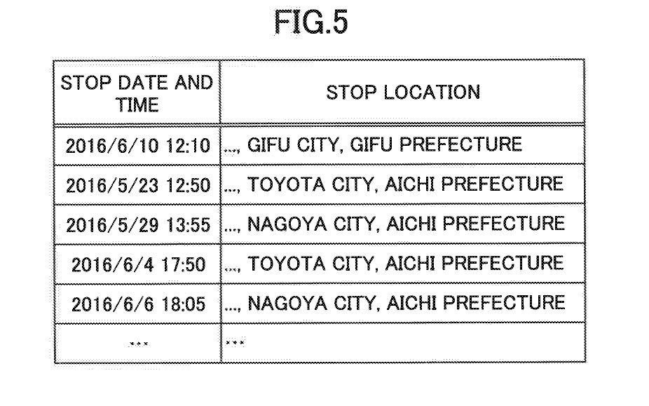

FIG. 5 depicts an example of the stop location information stored in the stop location storage unit 242. The stop location information can also be stored in a table of a database. The table includes attributes of “stop date and time” and “stop location”. In a field of “stop date and time”, information indicating a date and a time when the vehicle is stopped is registered. In a field of “stop location”, information indicating a location where the vehicle is stopped is registered. In the example of FIG. 5, each stop location is registered in a form of an address. However, a stop location may be presented in a form of a latitude and a longitude, or the like.

<Server>

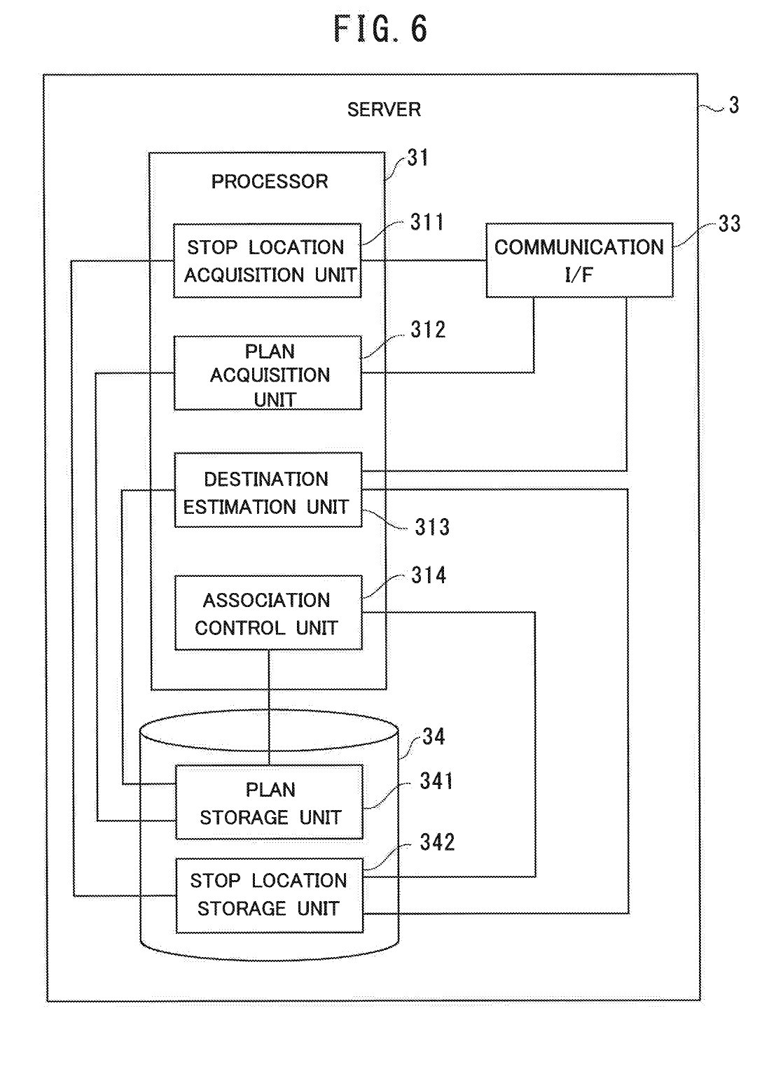

FIG. 6 is a functional block diagram depicting an example of the server. The server 3 is a so-called computer and includes a processor 31, a communication interface (I/F) 33, and a main memory 34. Note that the server 3 may further include an input/output interface that accepts an operation of the user and outputs information to the user. The processor 31 is a processing device such as a CPU. The communication I/F 33 is, for example, a communication module, a network interface card, a network adapter, or the like that performs communication based on a predetermined standard. The server 3 can communicate via the communication I/F 33 with another computer connected to the network 4. The main memory 34 includes main memories such as a RAM and a ROM, and one or more secondary storage such as an HDD, an SSD, an eMMC, and a flash memory. The main memory 34 stores a program to be executed by the processor 31 and “associated information” in which a stop location of the vehicle and a past plan of the user are associated with each other.

Moreover, the processor 31 executes a predetermined program, thereby serving as a function unit for each of a stop location acquisition unit 311, a plan acquisition unit 312, a destination estimation unit 313, and an association control unit 314. At least a partial area of the main memory 34 serves as a plan storage unit 341 in which plan information of the user is stored, and as a stop location storage unit 342 in which information indicating a stop location of the vehicle is stored in association with plan information of the user.

The stop location acquisition unit 311 acquires a stop location of the vehicle from the vehicle-mounted apparatus 2 via the communication I/F 33 and stores the stop location in the stop location storage unit 342.

The plan acquisition unit 312 acquires plan information of the user from the communication terminal 1 via the communication I/F 33 and stores the plan information in the plan storage unit 341. Note that the plan acquisition unit 312 may acquire plan information of the user from another apparatus that provides a schedule management service on the cloud computing. Information about past and future plans of the user stored in an external apparatus such as the communication terminal 1 is stored in the plan storage unit 341 in synchronization with the external apparatus.

The destination estimation unit 313 estimates a destination for future plan information of the user, based on a combination of past plan information of the user and a stop location of the vehicle. Specifically, with respect to a new plan registered by the user, if a similar plan was registered in the past, a destination is estimated based on a place visited at a time of the past plan.

The association control unit 314 registers stop information of the vehicle and past plan information of the user in association with each other, thus forming associated information. For example, in the associated information, information indicating a title of the plan is stored in association with the stop information including a stop date and time that falls within a predetermined time range from a scheduled starting time of the plan. Note that in the associated information, information indicating a stop location may be stored in association with the plan information.

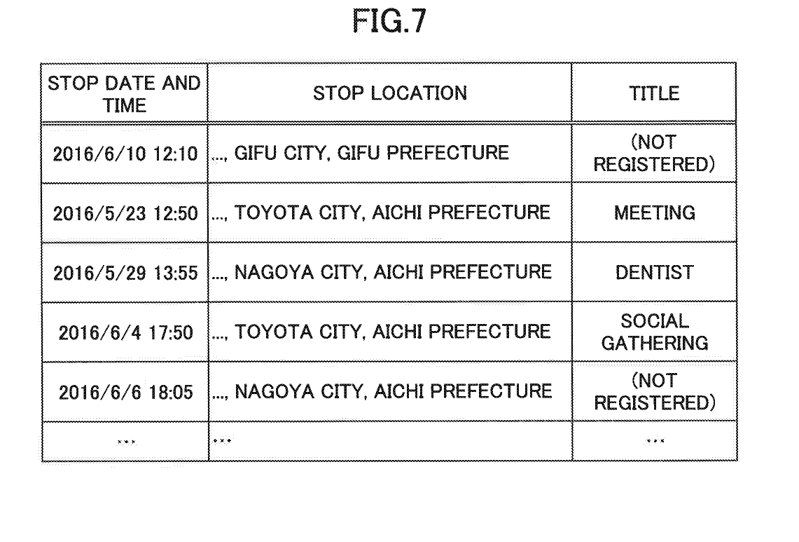

FIG. 7 depicts an example of “associated information”, which is formed by associating stop information with a title of a plan, stored in the stop location storage unit. The associated information can also be stored in a table of a database. The table of FIG. 7 includes attributes of “stop date and time”, “stop location”, and “title”. In a field of “stop date and time”, information indicating a date and a time when the vehicle is stopped is registered. In a field of “stop location”, information indicating a place where the vehicle is stopped is registered. Note that the information registered for “stop date and time” and “stop location” is information sent by the stop history transmission unit 211 of the vehicle-mounted apparatus 2. Although each stop location is registered in a form of an address, a stop location may be presented in a form of a latitude and a longitude, or the like. In a field of “title”, information indicating a detail of a plan is registered. For example, plan information is extracted from the plan storage unit 341 if a stop date and time falls within a predetermined time range before and after a starting date and time of the plan, and a title included in the extracted plan information is registered. In other words, in associated information, a title input by the user for plan information and a place where the vehicle was stopped on or around a starting time of the plan are registered in association with each other.

The plan information stored in the plan storage unit 141 of the communication terminal 1 is stored in the plan storage unit 341 in synchronization with the plan storage unit 141. A table structure is similar to the table structure depicted in FIG. 3.

<First Associated Information Creation Processing>

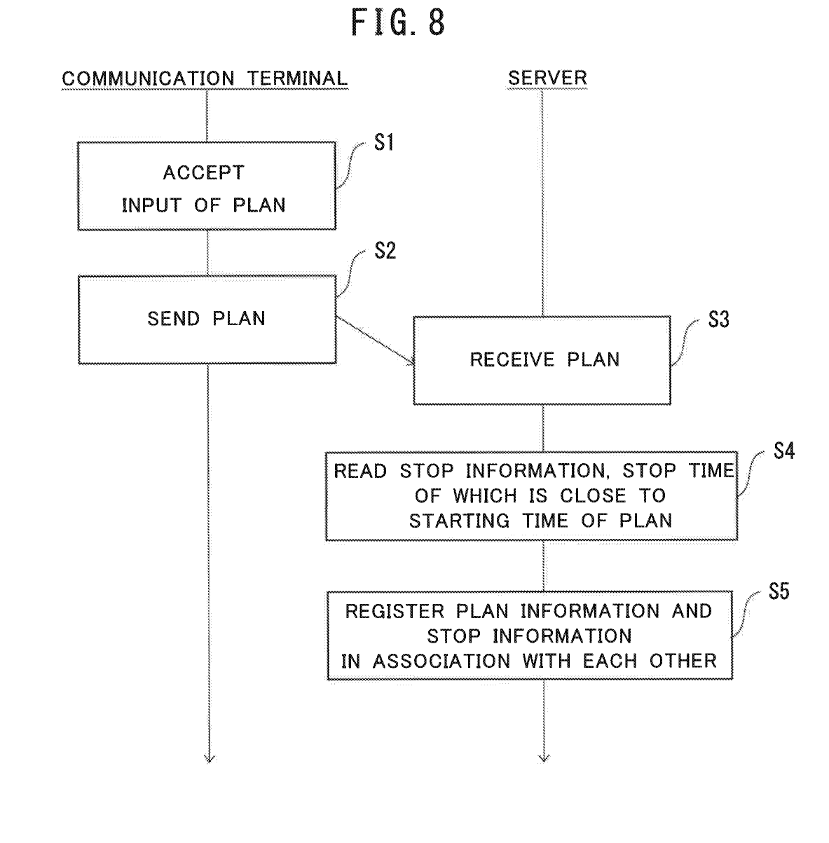

FIG. 8 depicts an example of first association processing. The association processing is performed after the user inputs a plan, or after the vehicle is stopped. FIG. 8 illustrates an example of processing following the user inputting a plan, which is performed, for example, after the user inputs a plan.

The plan registration unit 111 of the communication terminal 1 accepts an input of a plan based on an operation of the user (FIG. 8: S1). In this step, the plan registration unit 111 accepts an input of plan information to the predetermined schedule management function via the input/output I/F 12 and stores the plan information in the plan storage unit 141. For example, it is assumed that the plan information as depicted in FIG. 3 is input.

The plan synchronization unit 113 of the communication terminal 1 sends the input plan information (S2). In this step, the plan synchronization unit 113 sends the plan information stored in the plan storage unit 141 to the server 3 via the communication I/F 13.

Meanwhile, the plan acquisition unit 312 of the server 3 receives the plan information sent by the communication terminal 1 (S3). In this step, the plan acquisition unit 312 receives the plan information via the communication I/F 33 and stores the plan information in the plan storage unit 341. In the plan storage unit 341, the plan information as depicted in FIG. 3 is stored in synchronization with the communication terminal 1.

The association control unit 314 of the server 3 reads from the information stored in the stop location storage unit 342 a location where the vehicle was stopped on or around a starting time of the received plan (S4). Stop information and a title of the plan information are registered in association with each other, like the second to fourth records in FIG. 7. That is, if a location where the vehicle was stopped on or around a starting time of the plan is already registered in the stop location storage unit 342 (in other words, the user has input a past plan), a title in the plan storage unit 341 is registered in association with the stop information stored in the stop location storage unit 342. Note that if a plurality of pieces of stop information fall within a predetermined time range before and after the starting time of the plan, closest stop information may be extracted, or alternatively, stop information indicating that the vehicle was stopped before the starting date and time of the plan may preferentially be extracted, rather than stop information indicating that the vehicle was stopped after the starting date and time of the plan.

For example, when the plan depicted at the third record in FIG. 3 is received, the association control unit 314 reads stop information indicating that the vehicle was stopped 30 minutes or less before or after “18:00 on Jun. 6, 2016”, which is the starting date and time of the plan, from the stop location storage unit 342. Here, the information depicted at the fifth record in FIG. 7, which indicates that the vehicle was stopped at “18:05 on Jun. 6, 2016” at “ . . . , Nagoya City, Aichi Prefecture”, is read.

Note that if it is determined in S4 that stop information meeting the condition has not been registered in the stop location storage unit 342, the plan information is stored in the plan storage unit 341 in S3, and therefore the processing depicted in FIG. 8 is terminated without performing processing in S4 and S5.

The association control unit 314 of the server 3 registers the plan information and the stop information in association with each other (S5). In this step, the title of the plan information received in S3 is registered in association with the stop information read in S4.

For example, in association with the record depicted at the fifth record in FIG. 7, which indicates that the vehicle was stopped at “18:05 on Jun. 6, 2016” at “ . . . , Nagoya City, Aichi Prefecture”, “dentist” that is same as the third record in FIG. 3 is registered in a field of “title”. Information indicating an association between plan information and stop information, like the second to fourth records in FIG. 7, corresponds to “associated information”.

Thus, the first associated information creation processing is completed.

<Second Associated Information Creation Processing>

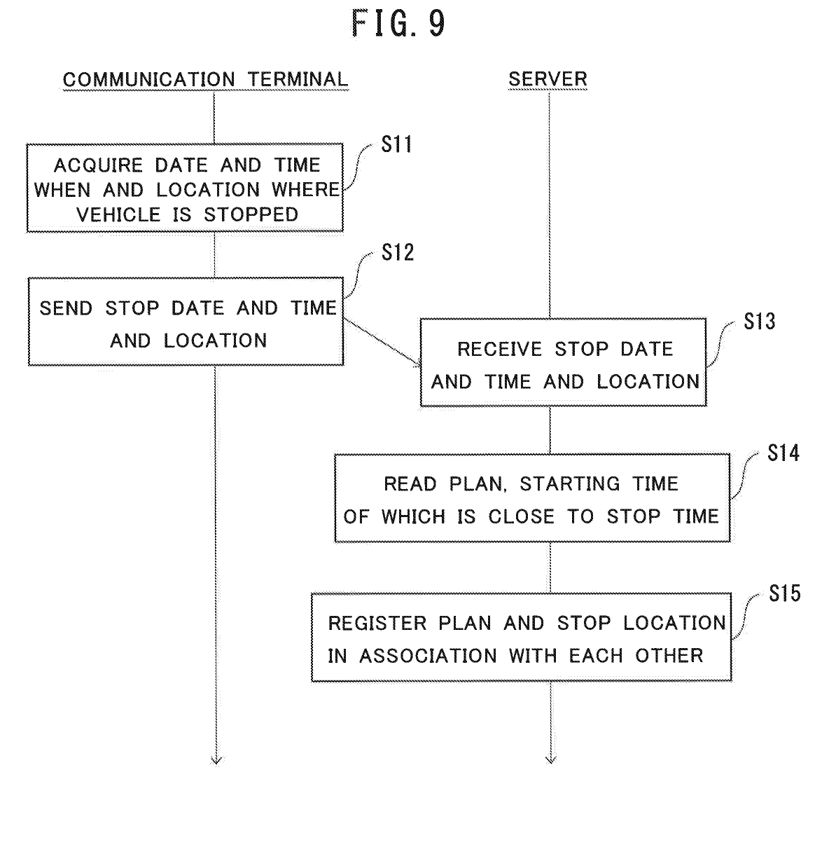

FIG. 9 depicts an example of second association processing. FIG. 9 illustrates an example of associated information creation performed after the vehicle is stopped. The second association processing may be performed after the accessory power supply of the vehicle is turned off and before operation of the vehicle-mounted apparatus 2 is terminated or at an arbitrary timing after the vehicle-mounted apparatus 2 is next activated.

The stop location recording unit 213 of the vehicle-mounted apparatus 2 acquires information indicating a date and a time when and a location where the vehicle is stopped (FIG. 9: S11). In this step, the stop location recording unit 213, upon receiving information indicating ACC-OFF from the ECU 26, acquires a date and a time when the vehicle was stopped from the built-in clock and also acquires a location where the vehicle was stopped from the GPS unit 25 and stores the acquired information in association with each other in the stop location storage unit 242. For example, the stop information as depicted in FIG. 5 is stored.

The stop history transmission unit 211 of the vehicle-mounted apparatus 2 sends the stop information including the stop date and time and the stop location stored in the stop location storage unit 242 to the server 3 (S12). In this step, the information stored in S1 is sent via the communication I/F 23.

Meanwhile, the stop location acquisition unit 311 of the server 3 receives the information indicating the stop date and time and the stop location from the vehicle-mounted apparatus 2 (S13). In this step, the stop location acquisition unit 311 receives the stop information from the vehicle-mounted apparatus 2 via the communication I/F 33 and stores the received stop information in the stop location storage unit 342.

The association control unit 314 of the server 3 reads from the plan storage unit 341 plan information including a starting time of a plan that is close to the stop time included in the stop information stored in the stop location storage unit 342 (S14). The stop information and a title of the plan information are registered in association with each other, like the second to fourth records in FIG. 7. That is, if the user has input a plan and when the vehicle was stopped on or around a starting time of the plan, a title of the plan in the plan storage unit 341 is registered in association with the stop information stored in the stop location storage unit 342. Note that if a plurality of plan information falls within a predetermined time range before and after the starting time of the plan, closest plan information may be extracted.

For example, when the stop information depicted at the fifth record in FIG. 5 is received, the association control unit 314 reads plan information from the plan storage unit 341 if stop date and time “18:05 on Jun. 6, 2016” falls within, for example, 30 minutes or less before and after a starting date and time of the plan. Here, the third record in FIG. 3, in which a title of a plan conducted at “18:00 on Jun. 6, 2016” is “dentist”, is read.

Note that if it is determined in S14 that plan information meeting the condition has not been stored in the plan storage unit 341, the stop information is stored in the stop location storage unit 342 in S13, and thereafter, the processing depicted in FIG. 9 is terminated without performing processing in S14 and S15.

The association control unit 314 of the server 3 registers associated information in which the plan information and the stop information are associated with each other (S15). In this step, the title of the plan information read in S14 is registered in association with the stop information received in S13.

For example, corresponding to the record depicted at the fifth record in FIG. 7, which indicates that the vehicle was stopped at “18:05 on Jun. 6, 2016” at “ . . . , Nagoya City, Aichi prefecture”, “dentist” that is same as the third record in FIG. 3 is registered in a field of “title”.

Thus, the second associated information creation processing is completed.

<First Destination Estimation Processing>

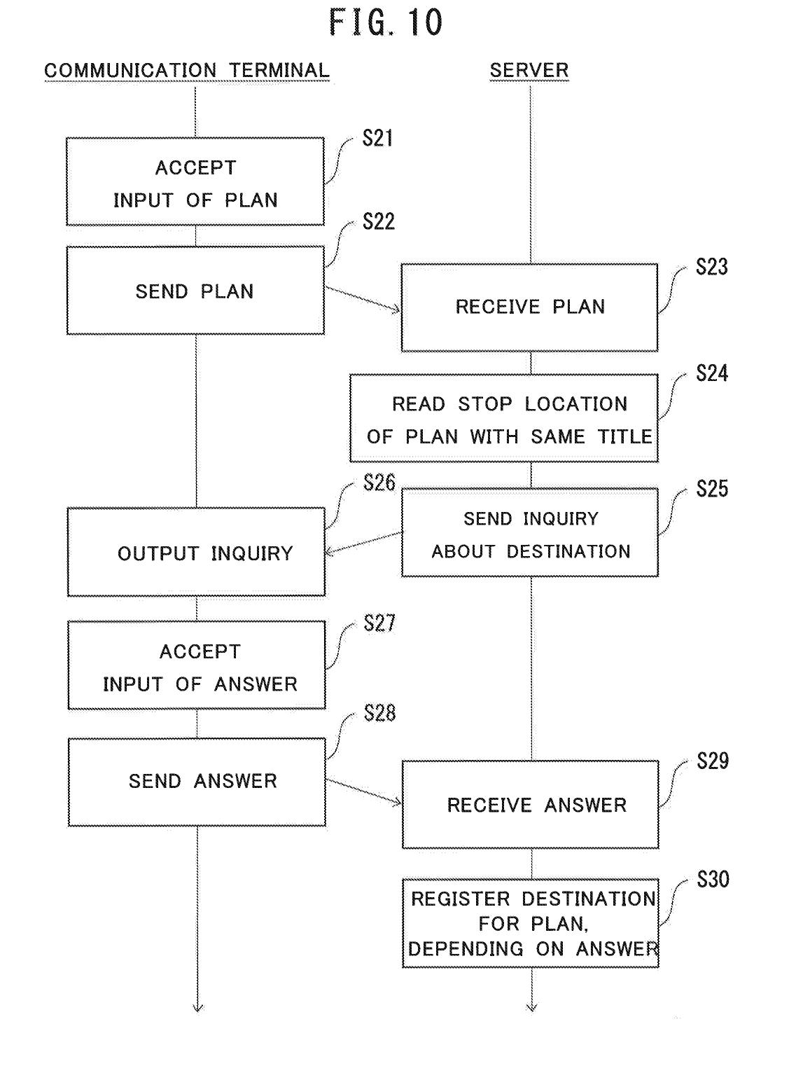

FIG. 10 depicts an example of first destination estimation processing. The destination estimation processing is performed after the user inputs a plan, or after the vehicle-mounted apparatus 2 is activated. FIG. 10 illustrates an example of processing performed after the user inputs a plan. Note that processing at S21 to S23 in FIG. 10 is same as the processing at S1 to S3 in FIG. 8.

The plan registration unit 111 of the communication terminal 1 accepts an input of a plan based on an operation of the user (FIG. 10: S21). In this step, the plan registration unit 111 accepts an input of plan information to the predetermined schedule management function via the input/output I/F 12 and stores the plan information in the plan storage unit 141. For example, it is assumed that the plan information as depicted in FIG. 3 is input.

The plan synchronization unit 113 of the communication terminal 1 sends the input plan information (S22). In this step, the plan synchronization unit 113 sends the plan information stored in the plan storage unit 141 to the server 3 via the communication I/F 13.

Meanwhile, the plan acquisition unit 312 of the server 3 receives the plan information sent by the communication terminal 1 (S23). In this step, the plan acquisition unit 312 receives the plan information via the communication I/F 33 and stores the plan information in the plan storage unit 341. In the plan storage unit 341, the plan information as depicted in FIG. 3 is stored in synchronization with the communication terminal 1.

The destination estimation unit 313 of the server 3 reads from the stop location storage unit 342 associated information in which a same title as a title of the plan information received in S23 is registered (S24). In this step, for plan information about a future plan, information indicating a stop location associated with past plan information that corresponds to this plan information about the future plan is read. Note that if there are a plurality of pieces of associated information in which the same title is registered, it is assumed that a record including a latest stop date and time is read. Based on the read information indicating the stop location, the destination estimation unit 313 estimates that the stop location is a destination of the plan indicated by the plan information received in S23.

For example, when the plan depicted at the third record in FIG. 3, the title of which is “dentist”, is received, information included in the third record in FIG. 7, the title of which is “dentist”, is read from the associated information depicted in FIG. 7. From the read record, it is found that when the user registered the plan information with the title of “dentist” in the past, the user visited “ . . . , Nagoya City, Aichi Prefecture”, which is registered as a stop location, on or around a starting time of the plan. In the present embodiment, it is estimated that the new plan for which the same title is registered has the same destination.

Note that in S24, if plan information having the same title is not in the stop location storage unit 342 and if a location where the vehicle was stopped on or around the starting time of the plan is already registered in the stop location storage unit 342, the processing at S4 and S5 in FIG. 8 may be performed. That is, the association control unit 314 creates associated information.

The destination estimation unit 313 sends an inquiry to the user about whether or not the estimated destination is correct (S25). In this step, the destination estimation unit 313 sends an inquiry about whether or not the estimated destination can be added to the plan information, to the communication terminal 1 via the communication I/F 33. In this event, the destination estimation unit 313 may read map information (not shown) stored in the main memory 34 of the server 3 or in another apparatus connected to the network 4, and use information such as a building name, a facility name, or a name of a tenant accommodated in a building corresponding to the stop location in FIG. 7 for the estimated destination, instead of an address.

Meanwhile, the inquiry processing unit 112 of the communication terminal 1 outputs the received inquiry to the user (S26). In this step, the inquiry processing unit 112 receives information including the estimated destination via the communication I/F 13. Moreover, the inquiry processing unit 112 outputs information inquiring whether or not the estimated destination can be added to the plan information, to the user via the input/output I/F 12.

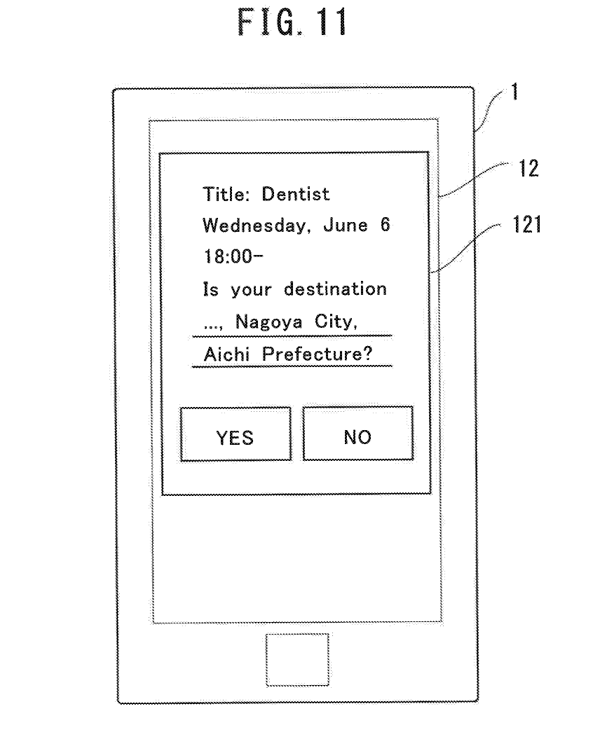

FIG. 11 depicts an example of an output for inquiring whether or not the estimated destination can be added to the plan information. In the example of FIG. 11, an inquiry display 121 is displayed on the input/output I/F 12 of the communication terminal 1. The inquiry display 121 includes a text for inquiring whether or not “ . . . , Nagoya City, Aichi Prefecture” is a correct destination of a plan with the title of “dentist” that starts at 18:00 on Wednesday, June 6, and buttons “Yes” and “No” for the user to tap to answer whether it is correct or not.

The inquiry processing unit 112 accepts an input of an answer from the user (FIG. 10: S27). In this step, an input of an answer from the user to, for example, a screen as depicted in FIG. 11 is accepted. That is, input information includes information indicating whether or not the destination estimated by the server 3 is correct. Note that when an answer indicating that the destination is correct is input, the inquiry processing unit 112 may register the estimated destination in a field of place included in the plan information registered in the plan storage unit 141. For example, the destination is added to a field of “place” of the plan information depicted in FIG. 3.

The inquiry processing unit 112 sends the accepted answer to the server 3 (S28). In this step, the inquiry processing unit 112 sends information indicating the answer to the server 3 via the communication I/F 13.

Meanwhile, the destination estimation unit 313 of the server 3 receives the answer (S29). In this step, the destination estimation unit 313 receives the information indicating the answer via the communication I/F 33.

The destination estimation unit 313 adds the destination to the plan information, depending on the answer (S30). In this step, when the destination estimation unit 313 receives the answer indicating that the destination is correct, the destination estimation unit 313 registers the estimated destination in a field of “place” included in the plan information registered in the plan storage unit 341.

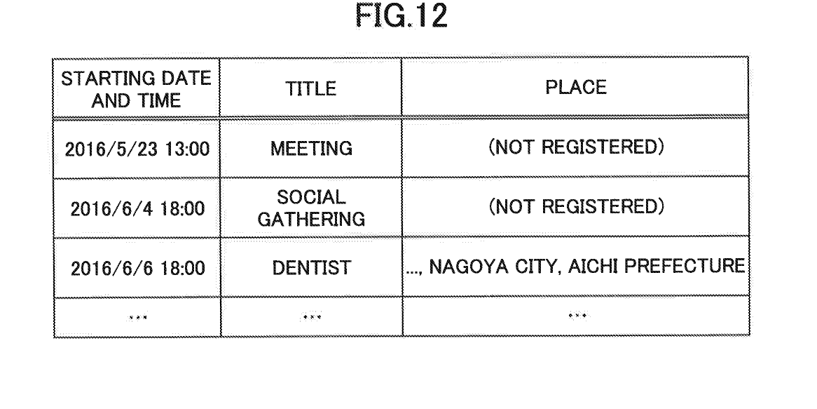

FIG. 12 depicts an example of the updated plan information. If the destination is added to a field of “place” in the plan storage unit 141 in S27, or if the destination is added to a field of “place” in the plan storage unit 341 in S30, the table depicted in FIG. 3 is updated as depicted in FIG. 12. In an example of FIG. 12, information indicating the destination of “ . . . , Nagoya City, Aichi Prefecture” is added to a field of “place” of the third record.

Thus, the first destination estimation processing is completed.

<Effects>

According to the destination estimation processing as described above, when the user registers an own plan in the communication terminal 1 or in the schedule management function on the cloud computing, a destination can be estimated and added even if the user does not input a place.

<Second Destination Estimation Processing>

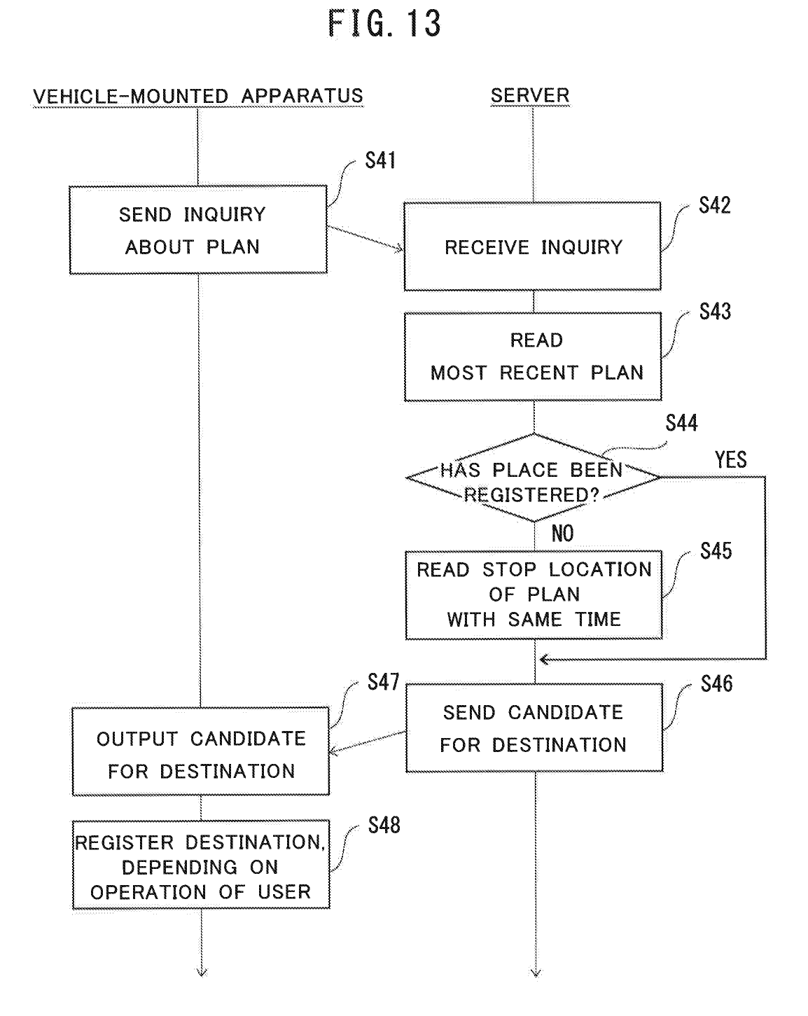

FIG. 13 depicts an example of second destination estimation processing. FIG. 13 illustrates an example of processing performed after the vehicle-mounted apparatus 2 is activated. That is, for example, when the accessory power supply of the ignition switch is turned on and the vehicle-mounted apparatus 2 is activated, the processing depicted in FIG. 13 is started.

The inquiry processing unit 212 of the vehicle-mounted apparatus 2 sends an inquiry about a future plan to the server 3 (FIG. 13: S41). In this step, the inquiry processing unit 212 sends an inquiry about whether or not plan information, the starting time of which is on or after a current time at the point of time of the processing, is registered, to the server 3 via the communication I/F 23. In other words, an inquiry about a plan in this step is an inquiry about a destination toward which the user will drive this time.

Meanwhile, the destination estimation unit 313 of the server 3 receives the inquiry about the plan from the vehicle-mounted apparatus 2 (S42). In this step, the destination estimation unit 313 receives information inquiring whether or not predetermined plan information has been registered, from the vehicle-mounted apparatus 2 via the communication I/F 33.

Thereafter, the destination estimation unit 313 reads a most recent plan (S43). In this step, the destination estimation unit 313 extracts, from the plan information stored in the plan storage unit 341, one record of a most recent plan for which a starting time later than the current date and time is registered. For example, from the table depicted in FIG. 12, plan information is extracted.

The destination estimation unit 313 determines whether or not a place where the plan is conducted has been registered in the extracted plan information (S44). In this step, it is determined whether or not location information has been registered in a field of “place” of the plan information extracted from the table depicted in FIG. 3 or 12. For example, if the plan information on the third line of the table of FIG. 3 is extracted in S43, it is determined that a place has not been registered. If the plan information on the third line of the table of FIG. 12 is extracted in S43, it is determined the place of “ . . . , Nagoya City, Aichi Prefecture” has been registered.

When it is determined that a place has not been registered (S44: NO), the destination estimation unit 313 reads from the stop location storage unit 342 associated information in which a same title as a title of the plan information read in S43 is registered (S45). In this step, for the most resent plan, information indicating a stop location associated with past plan information that corresponds to the plan information about the most resent plan is read. Based on the read information indicating the stop location, the destination estimation unit 313 estimates that the stop location is a destination of the plan indicated by the plan information received in S23.

After S45, or when it is determined in S44 that a place has been registered, the destination estimation unit 313 sends a candidate for destination to the vehicle-mounted apparatus 2 (S46). In this step, the destination estimation unit 313 sends the candidate for destination to the vehicle-mounted apparatus 2 via the communication I/F 33. The candidate for destination sent in this step is information indicating the destination estimated in S45, or information on the “place” that is determined to have been registered in the plan information in S44. In this event, the destination estimation unit 313 may read map information (not shown) stored in the main memory 34 of the server 3 or in another apparatus connected to the network 4, and use information such as a building name, a facility name, or a name of a tenant accommodated in a building corresponding to the stop location in FIG. 7 as the candidate for destination, instead of an address.

Meanwhile, the inquiry processing unit 212 of the vehicle-mounted apparatus 2 outputs the received candidate for destination to the user (S47). In this step, the inquiry processing unit 212 receives information including the candidate for destination via the communication I/F 23. Moreover, the inquiry processing unit 212 outputs information inquiring whether or not the candidate for destination can be registered as a destination on the navigation system, to the user via the input/output I/F ”2.

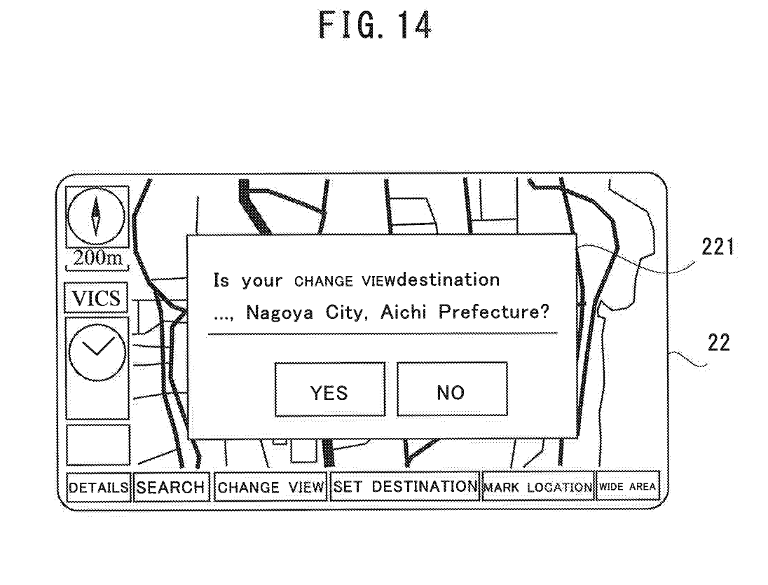

FIG. 14 depicts an example of an output for inquiring whether or not the candidate for destination can be set as a destination on the navigation system. In the example of FIG. 14, an inquiry display 221 is displayed on the input/output I/F 22 of the vehicle-mounted apparatus 2. The inquiry display 221 includes a text for inquiring whether or not “ . . . , Nagoya City, Aichi Prefecture” is a correct destination, and buttons “Yes” and “No” for the user to tap to answer whether it is correct or not.

The inquiry processing unit 212 then registers the destination, depending on an operation of the user (S48). When an answer indicating to set the candidate for destination is input, the inquiry processing unit 212 registers the candidate for destination as a destination on the navigation system. Note that the inquiry processing unit 212 sets nothing when an answer indicting not to set the candidate for destination is input.

<Effects>

According to the destination estimation processing as described above, when the vehicle-mounted apparatus 2 is activated (that is, when the user uses the vehicle), a candidate for destination to be registered in the navigation function included in the vehicle-mounted apparatus 2 can be proposed based on a plan registered by the user, or on a plan registered by the user and a history of visited places indicated by past location information of the vehicle. Even if the user does not input any information that can identify a destination in an own plan, in particular, it is possible to enhance accuracy of estimation of a destination. Moreover, it is possible to save the user time and trouble to set a destination on the navigation system each time the user drives, and consequently usability is enhanced.

Further, since a destination is complemented by the present system, the user can omit inputting a place by inputting a same title in plan information for plans having a same destination.

Particularly by associating a location where the vehicle was stopped within a predetermined time range before and after a starting date and time of a plan at S4 in FIG. 8 or at S14 in FIG. 9, it is possible to perform processing speedily with a simple database.

Furthermore, when the stop location storage unit 342 includes a plurality of pieces of associated information in which a same title is registered in S24, a record with a latest stop date and time is read, whereby it is possible to estimate a destination with high accuracy that reflects a most recent trend of titles registered by the user.

### Modification Example 1

The second destination estimation processing depicted in FIG. 13 may be performed not by the vehicle-mounted apparatus 2 but through a navigation program stored in an apparatus such as the communication terminal 1. The navigation program is, for example, a program including a function of presenting a current position and displaying a route to a destination on a map. That is, an apparatus other than the server 3 may perform the second destination estimation processing, and such an apparatus may be any of various apparatuses that set a destination estimated by the server 3 as a destination in a route search and provide route guidance. At this time, it is assumed that the apparatus such as the communication terminal 1 includes a GPS unit in addition to, for example, the configuration depicted in FIG. 2 and can acquire information indicating a location of the own apparatus. The second destination estimation processing depicted in FIG. 13 is started, for example, after the navigation program is started. Details of the processing are similar to those of the example of FIG. 13.

With this configuration, it is also possible to propose a candidate for a destination to be registered in the navigation function included in the apparatus such as the communication terminal 1, based on a plan registered by the user, or on a plan registered by the user and a history of visited places indicated by past location information of the vehicle. It is possible to save the user time and trouble to input a destination when the user checks a route by using the navigation program when the user goes out, and consequently usability is enhanced.

### Modification Example 2

Additionally, a departure time calculated backward from a starting time of a plan may be identified by calculating a required amount of time for moving based on a distance between a destination of the plan and a current place. The departure time may be notified to the user. If an alarm function is included in the schedule management function, such an alarm function may be used to notify the departure time.

<Others>

The present invention is not limited to the above-described embodiment, but changes and combinations may be made without departing from the scope of the present invention.

The present invention includes a computer program for executing the above-described processing methods and a computer-readable recording medium storing the program. The above-described processing can be implemented by causing a computer to read the recording medium and execute the stored program. The computer-readable recording medium refers to a recording medium that can accumulate information such as data and programs through an electrical, magnetic, optical, mechanical, or chemical action and is readable from the computer. Among such recording media, those removable from a computer include a flexible disk, a magneto-optical disk, an optical disk, a magnetic tape, a memory card, and the like. Moreover, recording media fixed to a computer include a hard disk drive, a ROM, and the like.

What is claimed is:

1. A destination estimation apparatus, comprising:
a storage unit that stores information about at least one stop location of a vehicle used by a user and information about at least one past plan of the user in association with each other; and
a destination estimation unit that estimates a destination with respect to information about a future plan of the user, based on the information about one of the at least one stop location that is associated with the information about one of the at least one past plan stored in the storage unit that corresponds to the information about the future plan.

2. The destination estimation apparatus according to claim 1, further comprising:
a plan acquisition unit that acquires from another apparatus the information about the at least one past plan and the information about the future plan, which are input by the user into the other apparatus, and stores the acquired information in the storage unit; and
a stop location acquisition unit that acquires information indicating a date and a time when and a location where the vehicle is stopped from a vehicle-mounted apparatus mounded on the vehicle, and stores the acquired information in the storage unit as the information about the at least one stop location of the vehicle.

3. The destination estimation apparatus according to claim 1, wherein the information about the at least one past plan of the user includes information indicating a starting date and time of the at least one past plan, the destination estimation apparatus further comprising:
an association control unit that reads from the storage unit information indicating a location where the vehicle was stopped within a predetermined time range by using the starting date and time of the at least one past plan as a reference, and stores the read information indicating the location of the vehicle and the information about the at least one past plan in association with each other.

4. The destination estimation apparatus according to claim 1, wherein the information about the future plan and the information about the at least one past plan further include information indicating details of the respective plans, and
with respect to the information about the future plan of the user, the destination estimation unit extracts the information about one of the at least one past plan that includes the same information indicating the detail of the plan as that of the information about the future plan, and estimates that a stop location indicated by the information about one of the at least one stop location that is associated in the storage unit with the extracted information about the one of the at least one past plan is a destination.

5. A destination estimation system, comprising:
the destination estimation apparatus according to claim 1; and
an apparatus that is connected to the destination estimation apparatus via a network and that provides route guidance toward a destination estimated by the destination estimation unit.

6. A destination estimation method to be performed by a computer, comprising:
an association step of storing information about at least one stop location of a vehicle used by a user and information about at least one past plan of the user in association with each other; and
a destination estimation step of estimating a destination with respect to information about a future plan of the user, based on the information about one of the at least one stop location that is associated with the information about one of the at least one past plan that corresponds to the information about the future plan.
